(19) United States
(12) Patent Application Publication
(10) Pub. No.: US 2016/0299280 A1
(43) Pub. Date: Oct. 13, 2016

(54) LIGHTGUIDE INCLUDING EXTRACTORS WITH DIRECTIONALLY DEPENDENT EXTRACTION EFFICIENCY

(71) Applicant: 3M INNOVATIVE PROPERTIES COMPANY, Saint Paul, MN (US)

(72) Inventors: David A. Ender, New Richmond, WI (US); Michael A. Haase, St. Paul, MN (US); Bing Hao, Woodbury, MN (US); Michael E. Griffin, Maplewood, MN (US); Jeremy K. Larsen, Farmington, MN (US); Karl A. Vick, Elko, MN (US)

(21) Appl. No.: 15/036,334

(22) PCT Filed: Dec. 30, 2014
(86) PCT No.: PCT/US2014/072649

§ 371 Date: May 12, 2016

Related U.S. Application Data
(60) Provisional application No. 61/922,217, filed on Dec. 31, 2013.

(51) Int. Cl. F21V 8/00

(52) U.S. Cl. CPC G02B 6/0036

(57) ABSTRACT

Lightguides are disclosed. In particular, lightguides including extractors with directionally dependent extraction efficiency are disclosed. The lightguide may include a series or array of directionally dependent light extractors. Certain configurations enabling the display of indicia and exemplary light extractor shapes are also disclosed.

### BACKGROUND

Lightguides are used to transport light through total internal reflection. Lightguides include extractors which divert or reflect light such that the light can pass out of the lightguide and in some cases be viewed by a viewer. The configuration of the extractors affects characteristics of the overall illumination viewable from systems including these lightguides.

### SUMMARY

In one aspect, the present disclosure relates to a lightguide. The lightguide includes first and second discrete spaced apart light extractors disposed on a major surface of the lightguide and configured to preferentially extract light when receiving light rays propagating within the lightguide along respective first and second ranges of optical paths, the preferentially extracted light rays exiting the lightguide along a range of viewing angles with respective minimum first and second extraction efficiencies, the second light extractor being disposed on a first optical path within the first range of optical paths, where a light ray propagating along the first optical path and extracted by the second light extractor exits the lightguide within the range of viewing angles with a third extraction efficiency substantially less than the minimum first extraction efficiency. In some embodiments, the third extraction efficiency is substantially less than the minimum second extraction efficiency.

In another aspect, the present disclosure relates to a lightguide including first and second discrete spaced apart light extractors disposed on a major surface of the lightguide, the first light extractor configured to preferentially extract light when receiving light rays propagating within the lightguide along a first range of optical paths, the preferentially extracted light rays exiting the lightguide along a first range of viewing angles with a minimum first extraction efficiency, the second light extractor disposed on a first optical path within the first range of optical paths. A light ray propagating along the first optical path and extracted by the second light extractor exits the lightguide within the first range of viewing angles with a second extraction efficiency substantially less than the minimum first extraction efficiency. In some embodiments, the range of viewing angles is within 20 degrees from a normal of the lightguide.

In yet another aspect, the present disclosure relates to a lightguide including first and second discrete spaced apart light extractors disposed on a major surface of the lightguide, the first light extractor configured to receive and extract a first light ray from a first edge location of the lightguide along a first optical path extending between the first edge location and the first light extractor, the extracted first light ray exiting the lightguide along a first viewing direction with a first extraction efficiency. The second light extractor is disposed on the first optical path and extracts the first light ray with a second extraction efficiency substantially less than the first extraction efficiency.

In another aspect, the present disclosure relates to a lightguide including first and second discrete spaced apart light extractors disposed on a major surface of the lightguide and configured to receive and extract respective first and second light rays from respective spaced part first and second edge locations of the lightguide along respective first and second optical paths extending between the respective first and second edge locations and the respective first and second light extractors, the extracted first and second light rays exiting the lightguide with respective first and second extraction efficiencies. The second light extractor is disposed on the first optical path and extracts the first light ray with a third extraction efficiency substantially less than the first and second extraction efficiencies.

In yet another aspect, the present disclosure relates to a lightguide including first and second discrete spaced apart light extractors disposed on a major surface of the lightguide and configured to preferentially extract light when receiving light rays propagating within the lightguide along respective first and second ranges of optical paths, each optical path in one of the first and second optical paths intersecting each optical path in the other one of the first and second optical paths.

In another aspect, the present disclosure relates to a lightguide including first and second discrete spaced apart light extractors disposed on a major surface of the lightguide and configured to receive and extract respective first and second light rays from respective spaced part first and second edge locations of the lightguide along respective and intersecting first and second optical paths extending between the respective first and second edge locations and the respective first and second light extractors. The extracted first and second light rays exit the lightguide with respective first and second extraction efficiencies, the first light extractor extracts a light ray received from the second edge location with an extraction efficiency substantially less than the first extraction efficiency, and the second light extractor extracts a light ray received from the first edge location with an extraction efficiency substantially less than the second extraction efficiency.

In some embodiments, the first and second discrete spaced apart light extractors are disposed on a same major surface. In some embodiments, at least one of the first and second light extractors is a wedge. In some embodiments, at least one of the first and second light extractors is a wedge with a positive or negative cylindrical sag. In some embodiments, at least one of the first and second light extractors is one of an asphere or a truncated asphere.

In one aspect, the present disclosure relates to a lightguide. The lightguide includes a plurality of spaced apart clusters of light extractors disposed on a major surface of the lightguide, each cluster of light extractors including at least first and second light extractors configured to preferentially extract light when receiving light rays propagating within the lightguide along respective first and second ranges of optical paths, no optical path in one of the first and second optical paths intersecting an optical path in the other one of the first and second optical paths.

In another aspect, the present disclosure relates to a lightguide including a plurality of groups of light extractors configured to extract light propagating within the lightguide to form an indicium for viewing. Each group of light extractors is configured to extract light to form a different portion of the indicium and each group of light extractors is configured to preferentially extract light received from a different corresponding edge location of the lightguide with an associated minimum extraction efficiency, such that each light extractor in any group of light extractors that receives a light ray from an edge location that corresponds to another group of light extractors, extracts the received light with an extraction efficiency that is substantially less than the minimum extraction efficiency associated with the another group of light extractors.

In yet another aspect, the present disclosure relates to a lightguide including a plurality of groups of light extractors extracting light propagating within the lightguide from a plurality of discrete spaced apart light sources disposed along one or more edges of the lightguide to form an image. There may be a one-to one correspondence between the plurality of groups of light extractors and the plurality of discrete spaced apart light sources. Each group of light extractors extracts light received from the corresponding light source with an associated minimum extraction efficiency and at least one light extractor in each group of light extractors receiving light from a light source corresponding to another group of light extractors and extracting the received light with an extraction efficiency that is substantially less than the minimum extraction efficiencies associated with the group of light extractors and the another group of light extractors

In another aspect, the present disclosure relates to a lightguide including a plurality of discrete spaced apart light extractors. The light extractors are configured to extract light propagating within the lightguide, the extracted light forming substantially overlapping first and second images at an emission surface of the lightguide, where each light extractor extracts light that is primarily part of only one of the first and second images.

In yet another aspect, the present disclosure relates to a lightguide including pluralities of first and second light extractors disposed on a major surface of the lightguide. The plurality of first light extractors extracts light propagating within the lightguide from one or more first light sources disposed along one or more edges of the lightguide with a minimum first extraction efficiency to form a first image at an emission surface of the lightguide and the plurality of second light extractors extracting light propagating within the lightguide from one or more second light sources disposed along one or more edges of the lightguide with a minimum second extraction efficiency to form a second image at the emission surface of the lightguide. The one or more first light sources are different than the one or more second light sources and the first and second images are non-overlapping. At least one first light extractor receives and extracts light propagating within the lightguide from the one or more second light sources with a light extraction efficiency substantially less than the minimum first extraction efficiency and at least one second light extractor receives and extracts light propagating within the lightguide from the one or more first light sources with a light extraction efficiency substantially less than the minimum second extraction efficiency. In some embodiments, the at least one first light extractor receives and extracts light propagating within the lightguide from the one or more second light sources with a light extraction efficiency substantially less than the minimum second extraction efficiency. In some embodiments, the at least one second light extractor receives and extracts light propagating within the lightguide from the one or more first light sources with a light extraction efficiency substantially less than the minimum first extraction efficiency.

In another aspect, the present disclosure relates to a lightguide including first and second discrete spaced apart light extractors disposed on a major surface of the lightguide and configured to preferentially extract light with respective minimum first and second extraction efficiencies when light rays propagating within the lightguide are received by the first and second light extractors from their input faces, at least one light ray that is preferentially extracted by the first light extractor being received by the second light extractor from a face other than the input face of the second light extractor before being received by the first light extractor from the input face of the first light extractor. The at least one light ray is extracted by the second light extractor with an extraction efficiency that is substantially less than the minimum first extraction efficiency.

### BRIEF DESCRIPTION OF THE DRAWINGS

FIG. 1 is a top perspective view of a wedge light extractor having directionally dependent extraction efficiency.

FIG. 2 is a top plan view of a lightguide including extractors with directionally dependent extraction efficiencies.

FIG. 3 is a top plan view of the lightguide of FIG. 2 receiving light from an edge location.

FIG. 4 is a top plan view of another lightguide including extractors with directionally dependent extraction efficiencies.

FIG. 5 is a top plan view of the lightguide of FIG. 4 receiving light from two edge locations.

FIG. 6 is a top plan view of a lightguide including clusters of extractors with directionally dependent extraction efficiencies.

FIG. 7 is a top plan view of another lightguide including clusters of extractors with directionally dependent extraction efficiencies.

FIG. 8 is a top plan view of a lightguide including extractors with directionally dependent extraction efficiencies.

FIG. 9 is a top plan view of another lightguide including extractors with directionally dependent extraction efficiencies.

### DETAILED DESCRIPTION

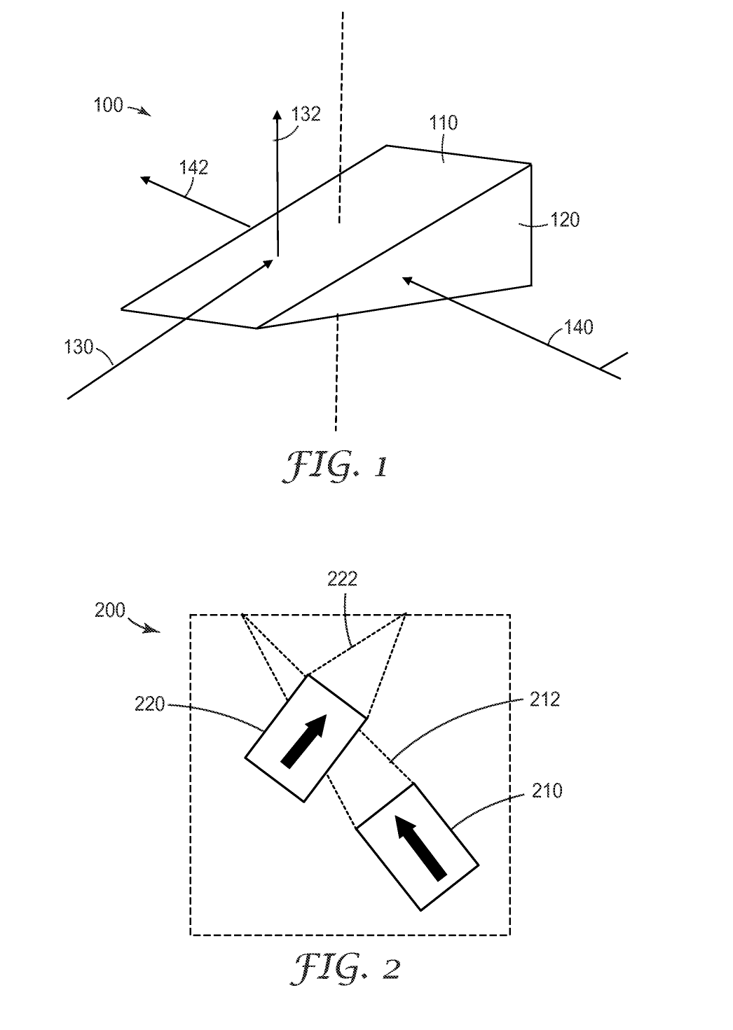

FIG. 1 is a top perspective view of a light extractor having directionally dependent extraction efficiency. Extractor 100 includes top face 110 and side face 120. To provide an example of directionally dependent extraction efficiency, first incident ray 130 and second incident ray 140 are shown. An axis passing through extractor 100 is provided for illustrative purposes, providing a reference for the azimuthal orientation of extractor 100.

The shape of extractor 100 may cause first incident ray 130 and second incident ray 140 to behave differently. Extractor 100, for example, if provided within a lightguide such that the index of refraction of or within extractor 100 is less than or substantially less than (e.g, in the case of air) the index of refraction of the lightguide, that may cause first incident ray 130, having a high incidence angle on top face 110, to be totally internally reflected off top face 110. Assuming extractor 100 is oriented or aligned such that the reference axis represents the thickness dimension of the lightguide, reflected ray 132 may be decoupled from being totally internally reflected or transported within the lightguide and exit the lightguide. In other words, reflected ray 132 is extracted. The interaction of incident light on the faces of extractor 100 may be modeled and predicted by the extractor shape and relative indices of refraction between extractor and lightguide. In contrast, second incident ray 140 is incident on side face 120 at a very low incidence angle, in this example near-normal incidence. Therefore, second incident ray 140 is transmitted through extractor 100. Transmitted ray 142, having no significant change in direction within the lightguide, may remain and continue to be transported within the lightguide. In some embodiments, second incident ray 140 may be reflected, nonetheless remaining within the lightguide, possibly incident on other extractors.

Extraction efficiency for an individual extractor may, at least for purposes of this application, be described as the ratio of light incident on an extractor to light extracted by that extractor. Note that this characteristic is independent of size (at least within reasonable size scales) and dependent largely on shape. Total extraction efficiency for an individual extractor describes the ratio of light incident on an extractor from any azimuthal direction and incidence angle. It also may be useful to characterize a light extractor—in particular an azimuthally asymmetric light extractor—as having directionally dependent extraction efficiencies. For example, the extractor in FIG. 1 may have a first extraction efficiency for light incident along the azimuthal direction of first incident ray 130, while having a second, substantially less extraction efficiency for light incident along the azimuthal direction of second incident ray 140. From another perspective, light may be extracted at different efficiencies depending on the input face of the extractor on which it is incident. First incident ray 130 and second incident ray 140 are substantially orthogonal and represent cases with significant differences in extraction efficiencies. In many embodiments, extraction efficiencies may instead vary smoothly or continuously as a function of azimuthal incidence direction from a lower extraction efficiency to a higher extraction efficiency and vice versa. Extractor efficiency may also, similarly, be a function of polar angle of incidence. In some cases, it may be useful to characterize useful extracted light as being extracted light within a certain angle from the normal or viewing direction (reference axis in FIG. 1), such as 20 degrees.

Extractor 100 is depicted as a wedge in FIG. 1, but may instead be many suitable shapes. For example, the shape of the faces, such as top face 110 may be designed or configured to have a positive or negative cylindrical sag. Light may be extracted within a range of extraction angles or viewing directions. Changing the shape of the faces of extractor 100, in particular preferentially extracting faces such as, in the configuration of FIG. 1, top face 110, may shift, widen, narrow, or even split the range of viewing angles from light extracted by extractor 100. In some embodiments, extractor 100 may be designed to preferentially extract light within a range of viewing angles, such as a 20 degree solid angle from the normal. Extractor 100 may be shorter, thinner, wider, or longer than the exemplary extractor shown in FIG. 1. Extractor 100 may have a face that is multifaceted, curved, concave, convex, spherical, aspherical, or any combination thereof Extractor 100 may have one or more truncated features or faces. Truncation may occur along either a horizontal plane, a vertical plane, or some other plane. In some cases, truncation along a horizontal plane may affect total extraction efficiency, while truncation along a vertical plane may affect aziumuthal or direction dependent extraction efficiency. Exemplary shapes include wedges, wedges with positive or negative cylindrical sag, concave-concave wedges (concave surfaces as both top and side faces, concave-convex wedges (concave surface as one and convex surface as the other of top and side faces), aspheres, trimmed or truncated aspheres or sections thereof, and the like.

In some embodiments, as in FIG. 1, extractor 100 may have one input face from which light is extracted with a higher efficiency. In other embodiments, extractor 100 may have a plurality of input faces from which light is extracted with a higher efficiency. In some embodiments, the term face may be inappropriate, because extractor 100 has a smooth curved shape. Nonetheless, in these cases, segments or portions of extractor 100 may have higher extraction efficiencies than other segments or portions of the extractor. For some extractors, it is appropriate to characterize them as preferentially extracting light along a range of optical paths. The range of optical paths may be characterized by the range of angles of incident light for which an extractor has a certain minimum extraction efficiency. This minimum efficiency may be 50%, 70%, 80%, 90%, 95%, or 99% of incident light, depending on the application.

Extractor 100 may be any suitable size. Although extractor efficiency is independent of the size of the extractor, the size of the extractor affects the total intensity of light extracted at that point. Further, design considerations such as resolvability of extractors by the human eye, speckle effects, and manufacturability may be factors in determining a desirable and suitable size or range of sizes for the extractors.

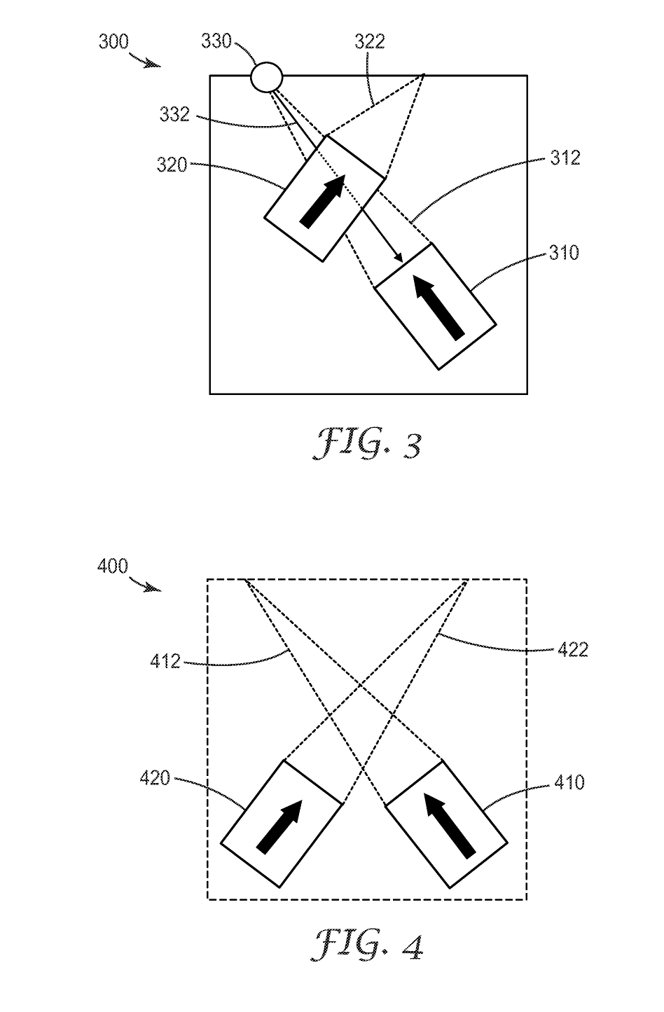

FIG. 2 is a top plan view of a lightguide including extractors with directionally dependent extraction efficiencies. Lightguide 200 includes first extractor 210 preferentially extracting first range of optical paths 212, and second extractor 220 preferentially extracting second range of optical paths 222. For the purposes of this application, or at least in terms of the figures within this application, the convention of an arrow indicating the extractor orientation by pointing toward the optical path or incident direction of greatest extraction efficiency is adopted. The range of optical paths associated with an extractor represents those paths that have an extraction efficiency over a minimum extraction efficiency. Depending on the particulars of the shape and design of the extractors, the range of associated optical paths need not be a continuous range. Moreover, the ranges of optical paths appear only two-dimensional because FIG. 2 is a plan view, however, the range of optical paths may have any three-dimensional shape, also controlled by careful design of extractor shape.

Lightguide 200 is shown with dotted line edges to indicate that the specific boundaries of the lightguide are not critical. Lightguide 200, however, may be made from any suitable material, including acrylic, polymeric materials, glass, and others. In some embodiments, lightguide 200 is formed from the same piece of material as the extractors, the extractors being an indentation or protrusion of the lightguide.

A replication tool may be used to fabricate the lightguides described herein. The replication tool, which may comprise metal, silicon, or other suitable materials includes the negative of the lightguide features including the protruded or recessed light extractors. The metal replication tool may be made from a master by electroplating or electroforming the metal, such as nickel, against the master and subsequently removing the master. A silicone replication tool can be made by curing a silicone resin against the master and subsequently removing the master.

The masters may be formed using a multi-photon (or, specifically, two-photon) photolithographic process which is described in, for example, U.S. Pat. No. 7,941,013 (Marttila et al.), which has been incorporated by reference herein. The multi-photon photolithographic process involves imagewise exposing at least a portion of a photoreactive composition to light sufficient to cause simultaneous absorption of at least two photons, thereby inducing at least one acid- or radical-initiated chemical reaction where the composition is exposed to the light, the imagewise exposing being carried out in a pattern that is effective to define at least the surface of a plurality of light extraction structures.

First extractor 210 and second extractor 220 may be the same shape or they may be different shapes. Depending on the desired application, the extractors may be similarly sized or they may have different sizes. First extractor 210 preferentially extracts light propagating within the lightguide along first range of optical paths 212. Correspondingly, second extractor 220 preferentially extracts light propagating within the lightguide along second range of optical paths 222. In FIG. 2, second extractor 220 is disposed on at least an optical path of the first range of optical paths.

Thus, light propagating within lightguide 200 may be propagating along one of the optical paths in first range of optical paths 212 that is incident on second extractor 220. However, because second extractor 220 is not oriented to preferentially extract light propagating within first range of optical paths 212, that light is extracted with an efficiency substantially less than light propagating within lightguide 200 that is incident on first extractor 210. In other words, light propagating within first range of optical paths 212 is extracted from second extractor 220 with an extraction efficiency that is substantially less than light propagating within first range of optical paths 212 extracted from first extractor 210. In some embodiments, substantially no light along an optical path within first range of optical paths 212 may be extracted by second extractor 220, while substantially all light along an optical path within first range of optical paths 212 may be extracted by first extractor 210.

FIG. 3 depicts the lightguide of FIG. 2 but with edges and a light source. Lightguide 300 includes first extractor 310 preferentially extracting first range of optical paths 312 and second extractor 320 preferentially extracting second range of optical paths 322. Light source 330 is positioned along an edge or at an edge location of lightguide 300. Light source generates ray 332, incident on both second extractor 320 and first extractor 310. As in FIG. 2, second extractor 320 is disposed along at least one of first range of optical paths 312 associated with first extractor 310.

Light source 330 is meant to be a generic illumination location (or apparent illumination location in the case of virtual images or reflected light) and is provided for better illustration of the general principles of lightguide 300. Light source 330, while depicted as a circle, may have any dimensional extent and may be any suitable light source or set of light sources, including LEDs, CCFLs, or incandescent bulbs. In some embodiments light source 330 may be or include a source of ambient light. Light source 330 may emit or generate light in any wavelength or range of wavelengths.

Ray 332, generated by light source 330, is propagating within lightguide 300 along one of first range of optical paths 312. Second extractor 320 is disposed along that path, and ray 332 is incident on a non-preferentially extracting face of second extractor 320 and is not propagating along one of second range of optical paths 322. Therefore, second extractor 320 extracts, if at all, ray 332 with a low extraction efficiency. In some cases, ray 332 is transmitted through second extractor 320 without significant deviation. In some embodiments, ray 332 may be 90% transmitted and 10% extracted, and different designs for the extractor shapes, particularly on the non-preferentially extracting face or faces, will provide different proportions. Ray 332 is then incident on first extractor 310, more specifically on a preferentially extracting face of first extractor 310, and may be extracted with a high extraction efficiency, or at least in some cases substantially higher than the extraction efficiency of second extractor 320 for the same ray or optical path from light source 330.

FIG. 4 is a top plan view of another lightguide including extractors with directionally dependent extraction efficiencies. Lightguide 400 includes first extractor 410 associated with first range of optical paths 412 and second extractor 420 associated with second range of optical paths 422. In the configuration of FIG. 4, each optical path in first range of optical paths 412 and second range of optical paths 420 intersect.

FIG. 5 is a top plan view of the lightguide depicted in FIG. 4, with the addition of edges and light sources to facilitate understanding of the general functioning principles of the lightguide. Lightguide 500 includes first extractor 510 and second extractor 520, associated as in FIG. 4 with first range of optical paths 512 and second range of optical paths 522, respectively. Disposed along or proximate edges of lightguide 500 are first light source 530 and second light source 540. As in FIG. 3, the shapes and precise location of the light sources were selected for ease of illustration and should be understood to provide merely exemplary edge locations.

First light source 530 at a first edge location generates both first light ray 532 and second light ray 534. First light ray 532 propagates along one of first range of optical paths 512, while second light ray 534 is not propagating along either first range of optical paths 512 or second range of optical paths 522. First light ray 532 is incident on first extractor 510 and is extracted with a certain first extraction efficiency. Second light ray 534 is incident on second extractor 520 and is extracted with an extraction efficiency substantially less than the first extraction efficiency.

Similarly, second light source 540 at a second edge location generates both third light ray 542 and fourth light ray 544. Third light ray propagates along one of second range of optical paths 522 while fourth light ray 544 is not propagating along either first range of optical paths 512 or second range of optical paths 522. Third light ray 542 is incident on second light extractor 520 and is extracted with a certain second extraction efficiency. Fourth light ray 544 is incident on first extractor 510 and is extracted with an extraction efficiency substantially less than the second extraction efficiency.

The concept depicted in the configuration of FIG. 5 may in some embodiments be utilized to selectively illuminate certain portions of lightguide 500. For example, if light comes from first light source 530 but not second light source 540 (e.g., first light source 530 is powered but second light source 540 is not), then the comparatively higher extraction efficiency of first extractor 510 vis-à-vis first light source 530 results in that extractor extracting more light than second extractor 520. Correspondingly, light coming from second light source 540 but not first light source 530 results in second extractor 520 extracting more light than first extractor 510.

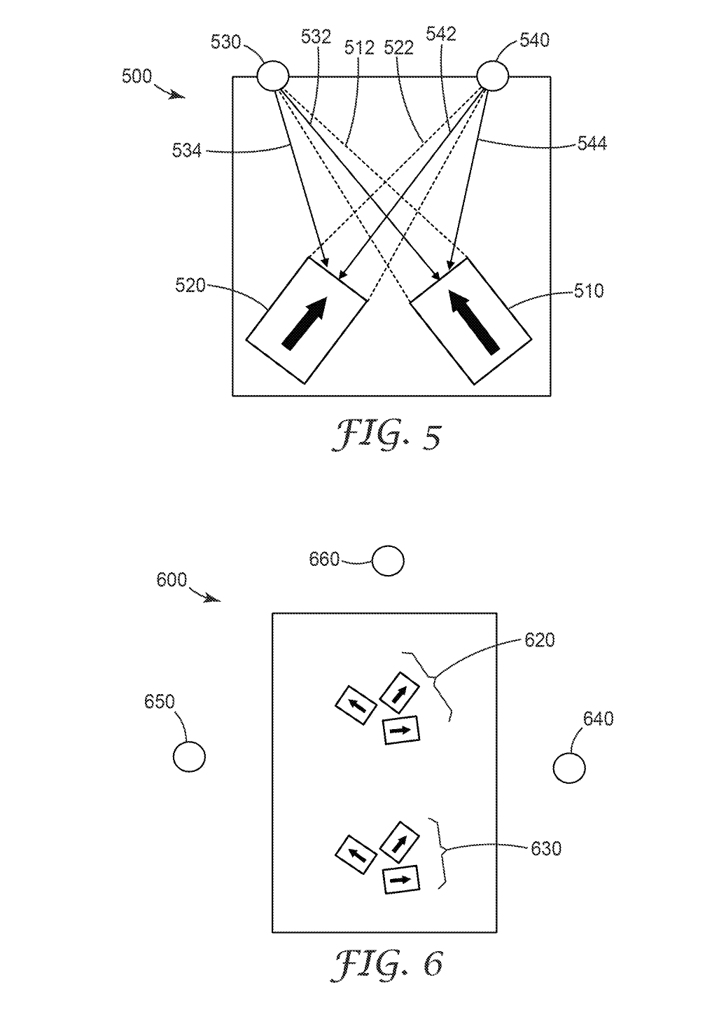

FIG. 6 is a top plan view of a lightguide including clusters of extractors with directionally dependent extraction efficiencies. Lightguide 600 includes first cluster 620, second cluster 630, first light source 640, second light source 650, and third light source 660. The light sources are placed to represent hypothetical edge locations for ease of explanation. FIG. 6 adopts the conventions of the previous figures for indicating the preferential direction of the light extractors within the clusters; however, for the ease of illustration the ranges of optical paths associated with each extractor is not shown.

First cluster 620 and second cluster 630 may have the same or similar number of light extractors or they might each have different numbers of light extractors. In some embodiments, the size or shape of extractors within first cluster 620 and second cluster 630 may vary to compensate for their position within lightguide 600; in some cases, this variation may help the uniformity of the extracted light. First cluster 620 and second cluster 630 will have a minimum of a plurality of light extractors, but may have any suitable number of light extractors. In some embodiments, each light extractor within a cluster of light extractors may have a different orientation. In some embodiments, several light extractors within each cluster of light extractors may have the same orientation.

Because of the complicated optical interaction between the clusters in lightguide 600 and the light sources disposed in exemplary edge locations, explanatory light rays are not provided to illustrate the optical path between these sources and each individual light extractor or each cluster. In some embodiments, however, no optical paths in the respective associated ranges of optical paths for each extractor in a cluster intersect one another. In some embodiments, no optical paths in the respective associate ranges of optical paths for each of two extractors in a cluster intersect one another. First light source 640, second light source 650, and third light source 660 may be selectively driven or powered to create interesting optical effects. For example, if first light source 640 is driven or powered, generating light incident on the clusters of light extractors depicted within lightguide 600, the three extractors within a cluster may extract the light with different extraction efficiencies. Similarly, if first light source 640 and second light source 650 are made to generate light, light from those two light sources may appear to be combined to a viewer where clusters having extractors preferentially extract light propagating in the lightguide from the edge locations of each of first light source 640 and second light source 650. Alternatively, no light from one, the other, or neither of first light source 640 and second light source 650 may appear where clusters lack one or both of the light extractors oriented to preferentially extract light from those directions.

This configuration—combined with, in some embodiments, a third light source 660 (or more) and careful extractor design and arrangement on lightguide 600—may result in tremendous design flexibility in displaying information. For example, the light sources may be selectively or sequentially driven, with each orientation of light extractor being distributed differently within the lightguide. A different overall extraction pattern is different for each edge location of the light source. For example, particularly in cases where all light sources emit the same or similar color light, selective illumination of each of the light sources may provide different effects. For example, the extractor clusters may extract a lot of light, less light, or very little light, depending on the distribution of extractor orientations across the clusters and the edge location of the light source. In effect, the selective driving of the light sources may act as a dimmer for otherwise undimmable light sources. Two or more light sources may be driven simultaneously as well, giving even more control over various brightness levels. If the light sources are different colors or have different wavelength ranges, the light sources can be separately driven to provide the appearance of different colors resulting from the controlled and predictable combination of light from the light sources at the clusters. In some embodiments, the distribution of the extractor orientation across the clusters may be such that the powering of a light source will make an image, indicium, logo, or security, verification, or authentication feature appear, which would otherwise be invisible or substantially invisible under illumination from other edge locations. Each orientation of extractor may be distributed through the clusters to make an animation as the light sources are cycled. Timers, microprocessors, or other input devices may be used to control the illumination of the light sources. In some embodiments, the illumination of the light sources and hence the appearance of a particularly imagewise extractor pattern may be programmable, switchable, or otherwise controllable through user input.

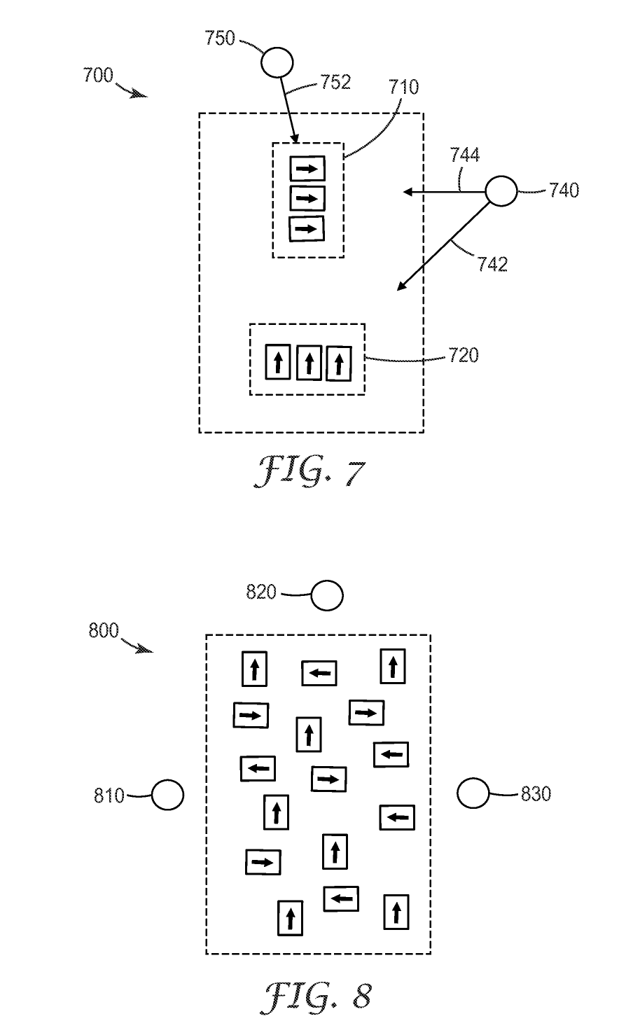

FIG. 7 is a plan view of another lightguide including clusters of extractors with directionally dependent extraction efficiencies. Lightguide 700, similar to lightguide 600 in FIG. 6, has clusters of similarly oriented light extractors as first indicium 710 and second indicium 720. Also positioned at an edge location are first light source 740 and second light source 750. First light source 740 generates first light ray 742 and second light ray 744. Second light source 750 generates third light ray 752.

The dashed lines in lightguide 700, besides the dashed lines for the lightguide to deemphasize the specific dimensions of lightguide 700, represent the approximate boundaries of the indicium, which are simplified for the ease of illustration. Any shape or size is possible with an arrangement of similarly oriented light extractors, such as any suitable logo, shape, word, or other indicium. The operation of lightguide 700 is similar to lightguide 600 of FIG. 6, with light being extracted differently based on the orientation of the directionally dependent light extractors and the edge location of the light source. For example, first indicium 710 receives light from first light source 740 as second ray 744 and from second light source 750 as third ray 752. The extractors of first indicium 710 are oriented, however, to preferentially extract light along optical paths from first light source 740, while extracting light along optical paths from second light source 750 at a substantially lower efficiency. Therefore, for example, if first light source 740 emitted blue light and second light source 750 emitted red light, and the two were emitting light simultaneously, first indicium 710 would extract the blue light at a much higher efficiency than the red light. Therefore, that portion of lightguide 700 corresponding to first indicium 710 would appear blue.

Similarly, second indicium 720 receives light from both first light source 740 as first ray 742 and from second light source 750 as third ray 752 (at least, that portion of third ray 752 that is not redirected or extracted by the extractors of first indicium 710). However, the extractors of second indicium 720 are configured to extract light along optical paths from second light source 750 at a much higher efficiency than light along optical paths from first light source 740. Thus, when the hypothetical described for first indicium 710 is applied to second indicium 720—that is, first light source 740 emits blue light and second light source 750 emits red light, second indicium 720 would appear red. Note that in some embodiments, because of the directionally dependent extraction properties of the extractors of lightguide 700, if the light sources were driven simultaneously, first indicium 710 may appear blue while second indicium 720 may appear red, with very little cross-talk or color mixing. Similarly, one or the other indicium may be illuminated with the other feature remaining substantially invisible. In some embodiments, an overall indicium on the lightguide is composed of non-overlapping segments, such as first indicium 710 and second indicium 720. There may be a one-to-one correspondence between the non-overlapping segments and the clusters of extractors, as substantially shown in FIG. 7.

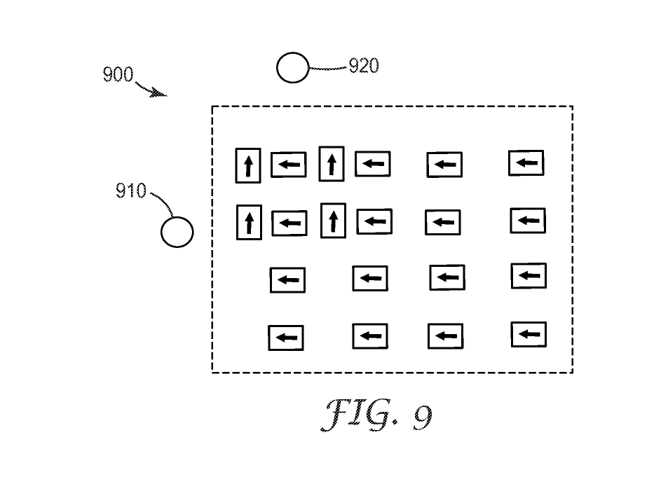

FIG. 8 is a top plan view of a lightguide including extractors with directionally dependent extraction efficiencies. Lightguide 800 includes a variety of light extractors, which are not individually labeled or identified in this figure. Further, first light source 810, second light source, 820, and third light source 830 are disposed at different edge locations. As for FIGS. 6-7, light from each light source edge location may illuminate a different subset of light extractors in lightguide 800. In this way, lightguide 800 may be configured such that different images, logos, or extractor patterns are visible depending on which edge location light from the light sources originates. Because extraction efficiency is not necessarily binary (all light being extracted or all light being transmitted or reflected within the lightguide), an extractor may be oriented to extract light at an intermediate efficiency from two or more edge locations.

FIG. 9 is a top plan view of another lightguide including extractors with directionally dependent extraction efficiencies. Lightguide 900 includes a plurality of extractors which are not individually labeled or identified. First light source 910 and second light source 920 are disposed at different edge locations. Similar to FIGS. 6-8, light from each light source edge location may illuminate a different subset of light extractors in lightguide 900. FIG. 9 depicts a superimposed pattern. For example, light from first light source 910 may provide substantially uniform illumination over the depicted portion of lightguide 900. Alternatively or in addition, light from second light source 920 may provide illumination only in the subset depicted with its light extractors oriented to preferentially extract light from the edge location of second light source 920. In a sense, light from first light source 910 forms a first image at the emission surface of lightguide 900 while light from second light source 920 forms a second image at the emission surface of the lightguide. Applications for this configuration include, for example, in the case of an automotive taillight, turn signals superimposed on running lights, which can be run simultaneously or separately and with different intensities and patterns. Other applications—for example, signage, general or decorating illumination including lamps and luminaires, transparent lighting such as sunroofs, windows, and skylights that can be selectively illuminated—are contemplated and may include the lightguides and configurations described herein. Further, such applications may alternatively or additionally include elements described in conjunction with other figures, for example, those described in FIGS. 6-8.

Descriptions for elements in figures should be understood to apply equally to corresponding elements in other figures, unless indicated otherwise. The present invention should not be considered limited to the particular embodiments described above, as such embodiments are described in detail in order to facilitate explanation of various aspects of the invention. Rather, the present invention should be understood to cover all aspects of the invention, including various modifications, equivalent processes, and alternative devices falling within the scope of the invention as defined by the appended claims and their equivalents.

1. A lightguide comprising first and second light extractors that are discrete, spaced apart, and disposed on a major surface of the lightguide and configured to preferentially extract light when receiving light rays propagating within the lightguide along respective first and second ranges of optical paths, the preferentially extracted light rays exiting the lightguide along a range of viewing angles with respective minimum first and second extraction efficiencies, the second light extractor being disposed on a first optical path within the first range of optical paths, wherein a light ray propagating along the first optical path and extracted by the second light extractor exits the lightguide within the range of viewing angles with a third extraction efficiency substantially less than the minimum first extraction efficiency.

2. The lightguide of claim 1, wherein the third extraction efficiency is substantially less than the minimum second extraction efficiency.

3-7. (canceled)

8. The lightguide as in claim 1, wherein the first and second discrete spaced apart light extractors are disposed on a same major surface.

9. The lightguide as in claim 1, wherein the range of viewing angles is within 20 degrees of a normal to the lightguide.

10. The lightguide as in claim 1, wherein at least one of the first and second light extractors is a wedge.

11. The lightguide of claim 10, wherein at least one of the first and second light extractors is a wedge with a positive or negative cylindrical sag.

12. The lightguide as in claim 1, wherein at least one of the first and second light extractors is one of an asphere or a truncated asphere.

13-14. (canceled)

15. A lightguide comprising a plurality of groups of light extractors extracting light propagating within the lightguide from a plurality of discrete spaced apart light sources disposed along one or more edges of the lightguide to form an image, there being a one-to one correspondence between the plurality of groups of light extractors and the plurality of discrete spaced apart light sources, each group of light extractors extracting light received from the corresponding light source with an associated minimum extraction efficiency, at least one light extractor in each group of light extractors receiving light from a light source corresponding to another group of light extractors and extracting the received light with an extraction efficiency that is substantially less than the minimum extraction efficiencies associated with the group of light extractors and the another group of light extractors.

16. The lightguide of claim 15, wherein the extracted light forms substantially overlapping first and second images at an emission surface of the lightguide, wherein each light extractor extracts light that is primarily part of only one of the first and second images.

17. A lightguide comprising pluralities of first and second light extractors disposed on a major surface of the lightguide, the plurality of first light extractors extracting light propagating within the lightguide from one or more first light sources disposed along one or more edges of the lightguide with a minimum first extraction efficiency to form a first image at an emission surface of the lightguide, the plurality of second light extractors extracting light propagating within the lightguide from one or more second light sources disposed along one or more edges of the lightguide with a minimum second extraction efficiency to form a second image at the emission surface of the lightguide, the one or more first light sources being different than the one or more second light sources, the first and second images being non-overlapping, at least one first light extractor receiving and extracting light propagating within the lightguide from the one or more second light sources with a light extraction efficiency substantially less than the minimum first extraction efficiency, at least one second light extractor receiving and extracting light propagating within the lightguide from the one or more first light sources with a light extraction efficiency substantially less than the minimum second extraction efficiency.

18. The lightguide of claim 17, wherein the at least one first light extractor receives and extracts light propagating within the lightguide from the one or more second light sources with a light extraction efficiency substantially less than the minimum second extraction efficiency.

19. The lightguide of claim 17, wherein the at least one second light extractor receives and extracts light propagating within the lightguide from the one or more first light sources with a light extraction efficiency substantially less than the minimum first extraction efficiency.

20. (canceled)
